(19) United States
(12) Patent Application Publication
(10) Pub. No.: US 2013/0149501 A1
(43) Pub. Date: Jun. 13, 2013

(54) METHOD FOR CONNECTING A FIBRE COMPOSITE COMPONENT TO A STRUCTURAL COMPONENT OF AN AIRCRAFT AND SPACECRAFT AND A CORRESPONDING ARRANGEMENT

(71) Applicants: Marco PACCHIONE, Hamburg (DE); Domenico FURFARI, Hamburg (DE)

(72) Inventors: Marco PACCHIONE, Hamburg (DE); Domenico FURFARI, Hamburg (DE)

(73) Assignee: AIRBUS OPERATIONS GMBH, Hamburg (DE)

(21) Appl. No.: 13/486,444

(22) Filed: Jun. 1, 2012

Related U.S. Application Data
(63) Continuation of application No. PCT/EP2010/068802, filed on Dec. 3, 2010.
(60) Provisional application No. 61/267,643, filed on Dec. 8, 2009.

(30) Foreign Application Priority Data
Dec. 8, 2009 (DE) 10 2009 047 671.7

(51) Int. Cl. B32B 7/08; B23P 13/00

(52) U.S. Cl. CPC B32B 7/08; B23P 13/00
USPC 428/172; 29/897.2

(57) ABSTRACT

In the case of a method for connecting a fibre composite component to a structural component of an aircraft and spacecraft, a metal foil is provided as a transverse reinforcement element between the fibre composite component and the structural component. It is formed with at least one anchoring portion which protrudes from the surface facing the fibre composite component and is inserted between the fibre composite component and the structural component. A corresponding arrangement is produced in accordance with this method.

### CROSS-REFERENCE TO RELATED APPLICATIONS

This application is a continuation of and claims priority to PCT/EP2010/068802 filed Dec. 3, 2010 which claims the benefit of and priority to U.S. Provisional Application No. 61/267,643, filed Dec. 8, 2009 and German patent application No. 10 2009 047 671.7, filed Dec. 8, 2009, the entire disclosure of which are herein incorporated by reference.

### FIELD OF THE INVENTION

The present invention relates to a method for connecting a fibre composite component to a structural component of an aircraft and spacecraft, and to a corresponding arrangement.

### BACKGROUND OF THE INVENTION

Although it is applicable to any fibre composite components, the present invention and the problem forming the basis thereof will subsequently be explained in more detail with reference to carbon fibre-reinforced plastics (CFRP) components (also referred to as fibre composite components), e.g. structural components of an aeroplane.

The stiffening of CFRP outer skins with CFRP stringers, CFRP frames, metallic frames and similar structural components in order to withstand the high loads encountered in the aeroplane sector, while adding the least possible weight, is generally known. The use of fibre composite components is very common in aeroplane construction e.g. for skin panels and the stiffening thereof by means of stringers. They are produced e.g. by prepreg technology, thermosetting methods and/or vacuum infusion methods for introducing a matrix, e.g. an epoxy resin, in semi-finished fibre products and subsequent curing.

A fibre composite component is constructed e.g. from semi-finished fibre products. Semi-finished fibre products are understood to be woven materials, fabrics and fibre mats.

Structural joining or connection points which have a specific damage tolerance are provided with metal foils between abutting surfaces, wherein a transverse reinforcement (by thickness) is added.

Composite laminates are susceptible to damage which is produced in a plane, such as e.g. delamination. Various composite technologies have been developed in order to improve the characteristics in the transverse direction, such as e.g. Z-pinning, stitching, tufting.

FIG. 1a-c show schematic sectional views for explanation of known methods of connecting a fibre composite material 2 to a structural component 3. In FIG. 1a, a connection portion 1 is connected between the fibre composite component 2 and the structural component 3 by inserting a first adhesive layer 5, e.g. an adhesive foil, thermoplastic or thermosetting material. Transverse reinforcements can be inserted in the z-direction. To this end, FIG. 1b illustrates so-called Z-pins 16 as an example. The Z-pins can be made e.g. of metal or composite material. In FIG. 1c, this arrangement can be a hybrid combination of a CFRP component 2 and structural component 3 consisting of metal, wherein the first adhesive layer is formed as described above. An x-direction extends in the longitudinal direction of the fibres, wherein the z-direction is perpendicular thereto. A y-direction extends perpendicularly with respect to the plane of the drawing and in the width of the components.

There are also examples of hybrid parts (CFRP/metal) which use mechanical connections between the metallic parts and composite material parts through the use of integrated or embedded features, in order to achieve additional strength and damage tolerance on account of metallic fixing of the metallic part in the laminate structure.

TWI (The Welding Institute) states a method which enables the producer to let an array of small arrangements penetrate into the laminate, as a result of which a co-cured mechanical connection is produced. However, in order to form these arrangements, material is used selectively from the surface, wherein the surface can be impaired as a result. The profile of the arrangements cannot be easily controlled and the surface is relatively rough, which can impair creep rupture strength of the original part.

In the case of so-called additive layer manufacturing, the geometry of these arrangements can be controlled in an improved manner.

Furthermore, there is a reproducible connection arrangement of metallic, specially perforated foils used in the automotive sector.

A further illustrative example is provided in document EP 1 801 427 A1 which describes a local metallic reinforcement of heavy duty connections of composite components.

### SUMMARY OF THE INVENTION

Against this background, it is an aspect of the present invention to provide an improved method for connecting a fibre composite component to a structural component. A further aspect is to provide a corresponding arrangement.

This aspect is achieved in accordance with the invention by a method having the features of claim 1 or by an arrangement having the features of claim 10. Accordingly, in the case of a method for connecting a fibre composite component to a structural component of an aircraft and spacecraft a metal foil is provided as a transverse reinforcement element between the fibre composite component and the structural component. The metal foil is formed with at least one anchoring portion which protrudes from the surface facing the fibre composite component. The metal foil is then inserted between the fibre composite component and the structural component.

In an alternative method, provision is made that the provided metal foil is provided as a transverse reinforcement element in a connection portion of the fibre composite component and structural component. It is formed with at least one anchoring portion which protrudes from a surface of the metal foil. The metal foil is then disposed on an outer side of the connection portion, wherein the at least one anchoring portion extends completely through the fibre composite component and extends into the structural component or extends completely through the structural component and extends into the fibre composite component.

An arrangement in accordance with the invention comprises a fibre composite component and a structural component of an aircraft and spacecraft, in which a metal foil is inserted in a connection portion of the fibre composite component and of the structural component as a transverse reinforcement element. The metal foil comprises at least one anchoring portion which protrudes from a surface of the metal foil.

Therefore, in comparison with the approaches stated in the introduction the present invention has the advantage that damage tolerance of a connection of a fibre composite component to a structural component is increased, in that a delamination in the plane of the fibre composite component is avoided or the propagation thereof is limited.

Such delaminations can occur in the case of connected composite components/hybrid connections as a consequence of incidental damage, such as e.g. manufacturing defects, unsuitable surface preparation, low-energy impacts, high peeling forces.

Furthermore, it is a significant advantage that the metal foil is a cost-effective component with a light intrinsic weight.

Moreover, the use of these metal foils restricts the number of fastening elements which are required for a damage tolerance regulation (e.g. “chicken fasteners”).

A still further advantage is apparent in that improved electrical conductivity serves to reduce the number of fastening elements which are used for lightning protection.

The subordinate claims contain advantageous embodiments and improvements of the present invention.

A basic idea behind the invention is to anchor a metal foil with at least one anchoring portion in a connection portion of the components of a connection of a fibre composite component to a structural component.

CFRP structures have well known limitations with regard to their characteristics in terms of damage tolerance. The insertion of a metal foil with anchoring portions which are suitable for anchoring the composite laminates between abutting surfaces of composite (or hybrid) connections provide a transverse reinforcement (by thickness), wherein the damage tolerance characteristics of the connection are improved.

The invention can be applied in various ways. For example, it can be used in the following fibre composite component and structural component combinations:
hybrid combination of CFRP and metal
thermally curable composite material (wet) and metal
connection of wet (uncured or partially cured) thermally curable laminate with thermally cured laminate
secondary connections of thermally curable laminates
thermoplastic welding of composite laminates.

In the case where the fibre composite component is uncured or is partially cured, the metal foil is connected to the fibre composite component by curing of same, wherein the at least one anchoring portion extends into the fibre composite component.

If the fibre composite component is cured, the metal foil can be connected to the fibre composite component by means of a adhesive layer therewith, wherein the at least one anchoring portion extends into the first adhesive layer.

In a further case, if the structural component is a metallic part or a cured fibre composite structure, the metal foil can be connected to the structural component by means of a second adhesive layer.

In a further embodiment it is provided that the metal foil is connected to the structural component by means of a further anchoring portion which protrudes from the surface facing the structural component and extends into the second adhesive layer.

The anchoring portions which protrude from the plane of the metal foil penetrate into the fibre composite component if it is uncured or is partially cured, or penetrate into the adhesive layer. In this case, they form a reinforcement in the z-direction, i.e., in a direction protruding from the plane of the metal foil, e.g. perpendicularly or at a predetermined angle. As a consequence, delamination in the plane of a fibre composite component can be avoided or halted.

If the structural component is an uncured or partially cured fibre composite structure, the metal foil is formed with a further anchoring portion which protrudes from the surface facing the structural component, i.e., the metal foil then has anchoring portions which protrude on each side. The further anchoring portion is then connected to the structural component by curing of same, wherein the further anchoring portion extends into the structural component.

It is also possible for the metal foil initially to be connected to the structural component by means of only one anchoring portion by curing and then to be connected to the fibre composite component by further curing. It is naturally also possible to perform co-curing.

In a further case, if the fibre composite component and the structural component each comprise a thermoplastic laminate, the metal foil is formed with at least one further anchoring portion which protrudes from the surface facing the structural component, so that an anchoring portion protrudes on each side of the metal foil. The fibre composite component can then be welded to the structural component after insertion of the metal foil. The anchoring portions extend into the respectively associated component.

In this case it can be advantageous if during the welding procedure the metal foil is used at least partially for introducing heat, e.g. by induction.

The metal foil can be formed with the anchoring portions e.g. by means of punch-bending methods, high-speed metal removal, electron beam processing, additive layer manufacturing methods and/or the like. This offers the advantage of rapid and cost-effective production by means of known methods. The shape of the anchoring portions can be different in dependence upon the technology used.

The at least one anchoring portion and/or the further anchoring portion can be formed, for instance, as a punch-bent part and can comprise anchoring elements which are disposed substantially perpendicularly or at a predetermined angle with respect to the respective surface of the metal foil. The anchoring portions can be formed in one piece with the metal foil.

The at least one anchoring portion and/or the further anchoring portion can comprise anchoring pins which are produced by means of electron beam processing, additive layer manufacturing methods and/or the like. The anchoring pins can also be separately produced and then welded to the metal foil.

The anchoring elements and/or anchoring pins can also be provided e.g. with barbs, serrations, points and/or the like.

The metal foil can comprise e.g. titanium material or a steel or special steel material. The metal foil material must be resistant to the materials of the arrangement and the auxiliary substances thereof.

Prior to use in the arrangement, the metal foil can be subjected to a corresponding surface treatment or preparation, so as to ensure optimum adhesion between the metal foil material and the materials of the components of the arrangement, e.g. matrix, fibres, adhesives.

Connections which are currently riveted, such as e.g. longitudinal connections of fuselage parts, circumferential connections, can be bonded or adhered through the use of the invention. In addition, highly stressed locations (e.g. stringer run-outs) can benefit from this local reinforcement.

The invention will be explained in greater detail hereinafter with the aid of exemplified embodiments with reference to the accompanying Figures of the drawing, in which

### BRIEF DESCRIPTION OF THE DRAWINGS

FIGS. 1a-c show schematic sectional views for explanation of methods for connecting a fibre composite component to a structural component in accordance with the Prior Art;

FIGS. 2-6 show schematic sectional view of the first to fifth exemplified embodiments for explanation of a method in accordance with the invention for connecting a fibre composite component to a structural component;

FIGS. 7a-d show schematic sectional views of method steps for the second exemplified embodiment of FIG. 3;

FIGS. 8-11c show schematic perspective views of the first to third exemplified embodiments of anchoring portions; and

FIG. 12 shows schematic perspective views of anchoring elements and pins.

### DETAILED DESCRIPTION OF THE INVENTION

In the Figures, like reference numerals designate like or functionally equivalent components unless stated to the contrary. Coordinates x, y and z serve to facilitate orientation.

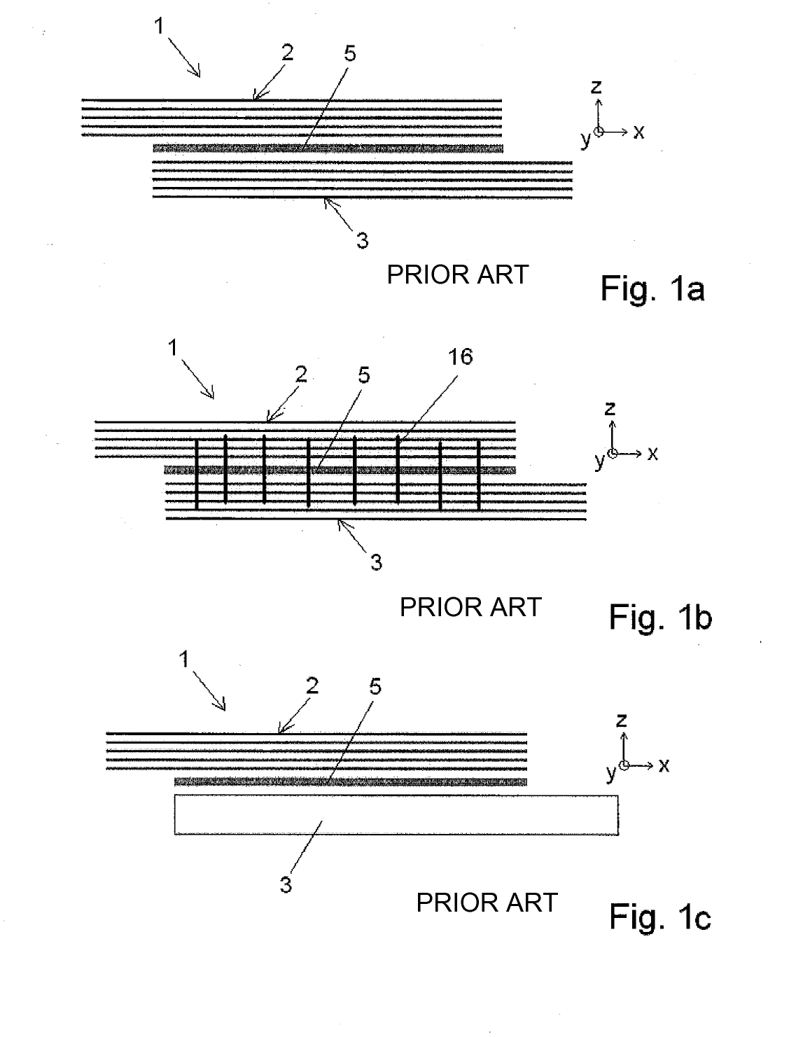

FIGS. 1a-c have already been explained in the introduction of the description.

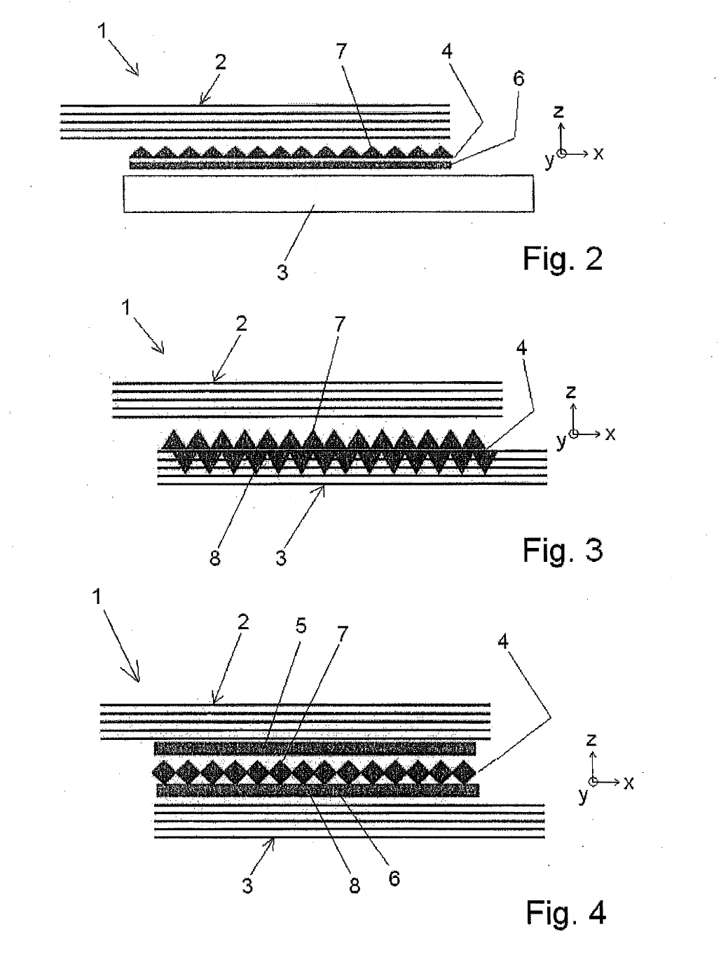

FIG. 2 shows a schematic sectional view of a first exemplified embodiment for explanation of a method in accordance with the invention for connecting a fibre composite component 2 to a structural component 3. In this case, the fibre composite component can be a prepreg or even a fibre fabric which is impregnated with a matrix.

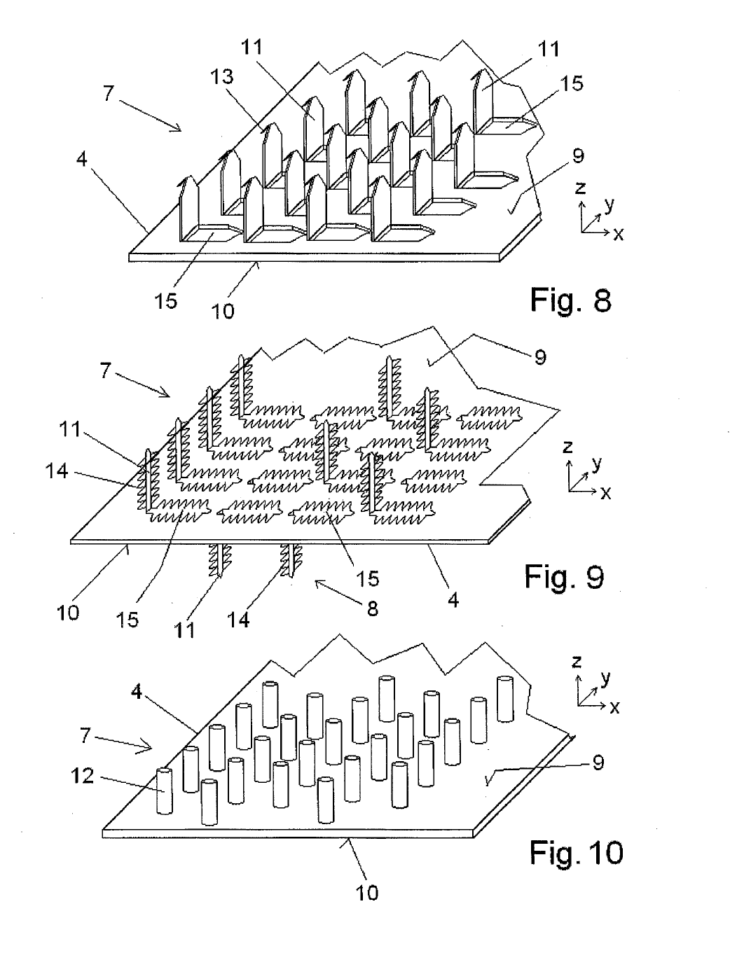

A metal foil 4 is formed in such a manner that it acquires an anchoring portion 7 on the side facing the fibre composite component 2. This can be performed e.g. by punch-bending methods, high-speed metal removal, electron beam processing, additive layer manufacturing methods and/or the like. A further description is provided hereinafter in connection with FIGS. 8 to 12. In this example, the fibre composite component 2 is uncured (or is partially cured), wherein the structural component 3 is a metal part.

The metal foil 4 is connected to the structural component 3 by means of an adhesive layer 6. On the other side, the anchoring portion 7 penetrates in the z-direction into the fibre composite component 2 and is connected thereto by curing of the fibre composite component 2. Adhesion and curing can also be performed simultaneously.

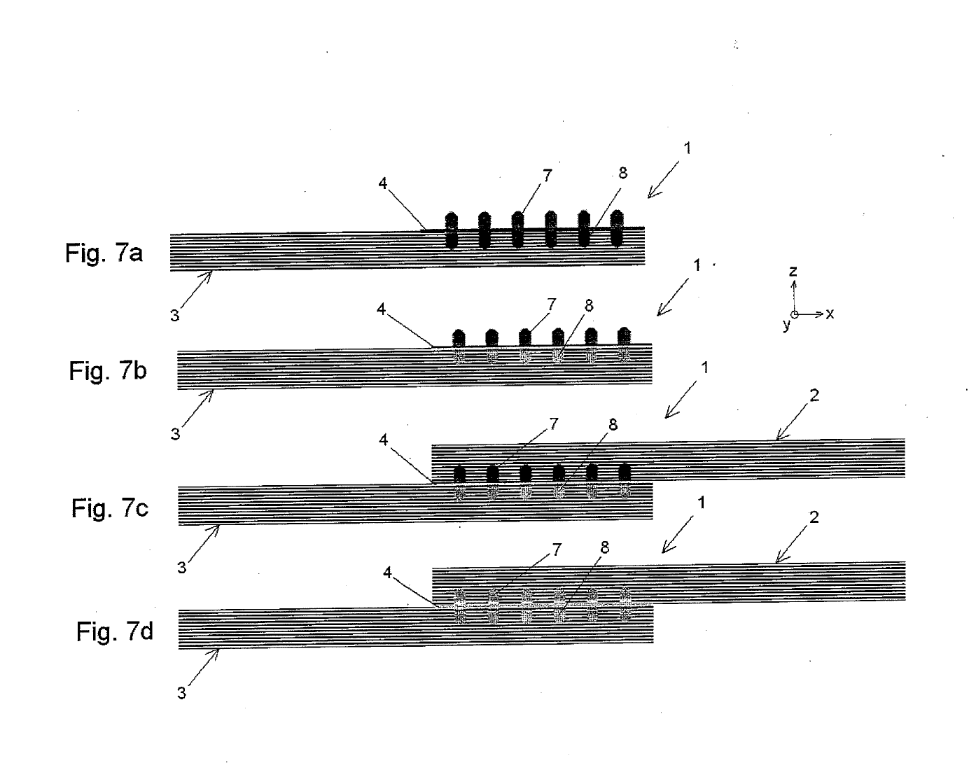

FIG. 3 illustrates a schematic sectional view of a second exemplified embodiment. In this case, the fibre composite component 2 and the structural component 3 are fibre composite materials. In this case, there are two options. In the first instance, the metal foil 4, which is formed in such a manner that on both sides it comprises anchoring portions 7 and 8 which protrude from the plane of the metal foil (here x-y plane) in the z-direction perpendicularly or at a predetermined angle, can be connected to the structural component 3. In so doing, the second anchoring portion 8 which protrudes on the side of the metal foil 4 facing the structural component 3 extends into the structural component 3 and is connected thereto by curing of the structural component 3. The connection of the first anchoring portion 7 to the fibre composite component 2 is then performed in the same manner. This is explained in greater detail hereinafter in FIGS. 7a-d. The second option is to connect both anchoring portions simultaneously by simultaneous curing of the arrangement.

If in this case the fibre composite component 2 and the structural component 3 are already cured, then in accordance with the illustration of a third exemplified embodiment shown in FIG. 4 they can be connected by means of adhesive layers 5 and 6. To this end, the metal foil 4 is formed with two anchoring portions 7 and 8 and is inserted between the components 2 and 3 after application of the adhesive layers 5 and 6 onto the abutting surfaces, i.e., the opposite sides of the fibre composite component 2 and the structural component 3. The anchoring portions 7 and 8 extend in each case into the associated adhesive layer 5 and 6 and are connected thereto by curing of the adhesive layers 5 and 6. The adhesive layer 5 is also connected in this manner to the fibre composite component 2. The same occurs with the adhesive layer 6 and the structural component 3. In this manner, a connection of the fibre composite component 2 and the structural component 3 is produced.

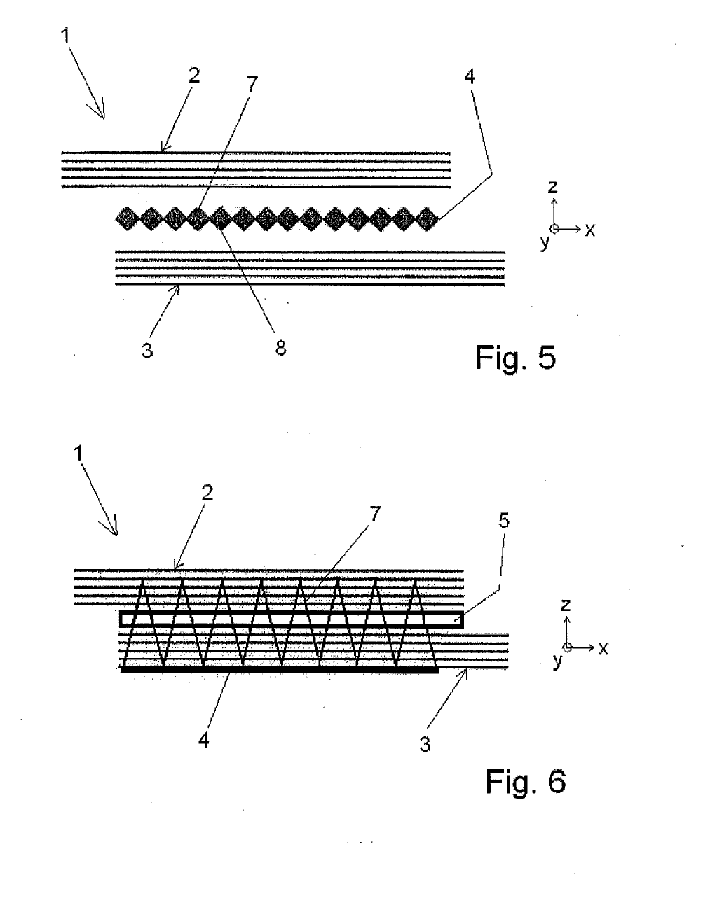

FIG. 5 illustrates a fourth exemplified embodiment in which the fibre composite component 2 and the structural component 3 comprise thermoplastic composite materials. The metal foil 4 is formed with two anchoring portions 7 and 8. It is then inserted between the fibre composite component 2 and the structural component 3. The first anchoring portion 7 extends in the z-direction into the fibre composite component 2, wherein the second anchoring portion 8 likewise extends in the z-direction into the structural component 3. Welding is then effected on the thermoplastic components which are reinforced in the z-direction in addition by the anchoring portions 7 and 8 in the z-direction [sic].

The adhesive layers 5, 6 can be used e.g. as an adhesive foil or adhesive paste.

Of course, further embodiments are possible. In the case of all embodiments of the connection, the bonded or adhered or welded connection is permanent. It can only be broken by destruction of the bond layers (adhesive layer or welded layer) and of the metal foil 4.

A further common characteristic of the embodiments is that under normal conditions or during normal operation the loads are transferred by the adhesive layers. The metal foils assist the transfer of loads only when there is a local flaw and/or failure in adhesion. The anchoring portions 7, 8 of the metal foil 4 form a transverse reinforcement of the connection in the connection portion 1 transverse to the x-direction or at an angle, e.g. perpendicular to the x-y plane.

FIG. 6 illustrates a fifth exemplified embodiment in which the metal foil 4 is formed with an anchoring portion 7 and is disposed on an outer side of the connection portion 1. In this case, it is the outer side of the structural component 3, but it can also be the outer side of the fibre composite component 2. In the case of the fifth exemplified embodiment, the structural component 2 has an uncured or partially cured fibre composite material and the fibre composite component 2 is likewise uncured or partially cured. The anchoring portion 7 is formed in such a manner that it completely penetrates the structural component 3 in the z-direction and extends further into the fibre composite component 2. An adhesive layer 5 can also be provided. By simultaneous curing of the arrangement, the fibre composite component 2 and the structural component 3 can be connected as described above.

FIGS. 7a-d illustrate schematic sectional views of method steps for the second exemplified embodiment of FIG. 3. Since the metal foil 4 has been formed with two anchoring portions 7 and 8, it is introduced with the second anchoring portion 8 in the connection portion 1 into the uncured or partially cured structural component 3 (FIG. 7a). The structural component 3 is then cured and is connected to the metal foil 4 by means of the second anchoring portion 8 and the metal foil 4 itself (FIG. 7b). In FIG. 7c, the fibre composite component 2, e.g. preferably as a prepreg, in the connection portion 1 is applied to the first anchoring portion 7 of the metal foil 4, the metal foil 4 and the structural component 2, wherein the first anchoring portion 7 extends into the fibre composite component 2. Finally, in FIG. 7d the fibre composite component 2 is cured, wherein the fibre composite component 2 and the structural component 3 are connected by means of the metal foil 4 and its anchoring portions 7 and 8 which form a transverse reinforcement of the connection portion 1.

5

FIG. 8 shows a schematic perspective view of a first exemplified embodiment of an anchoring portion 7. The metal foil 4 is processed in this case by means of a punch-bending method such that anchoring elements 11 in the form of surface elements, which are tapered at the top, are punched out of the metal foil 4 as punched-out parts 15 and are bent upwards through about 90° with respect to the x-y plane of the metal foil 4, wherein they protrude from a first surface 9 of the metal foil 4. Other predetermined angles, either identical or different, can also be used. Disposed at the free ends of the anchoring elements 11 are barbs 13 which form an additional anchoring arrangement. In FIG. 6, a second surface 10 of the metal foil 4 is located on the underside of the metal foil 4.

FIG. 9 shows a schematic perspective view of a second exemplified embodiment of anchoring portions 7 and 8. On the first surface 9 of the metal foil 4, anchoring elements 11 are punched out protruding perpendicularly from the first surface 9 and form the first anchoring portion 7. A second anchoring portion 8 is formed by bending punched-out anchoring elements 11 downwards, wherein the second anchoring portion 8 protrudes from the second surface 10 of the metal foil 4. In this example, the sides of the anchoring elements 11 are provided with serrations 14, whereby the anchoring elements 11 are afforded a larger surface for connection purposes.

An adhesive layer or matrix material can pass through the punched-out parts 15 and thus provide a more intimate connection of the fibre composite component 2 and structural component 3.

Finally, FIG. 10 shows a third exemplified embodiment of an anchoring portion 7 which protrudes from the surface 9 of the metal foil 4 and consists of anchoring pins 12. These anchoring pins 12 can be formed e.g. by additive layer manufacturing, in a chemical and/or electrochemical manner.

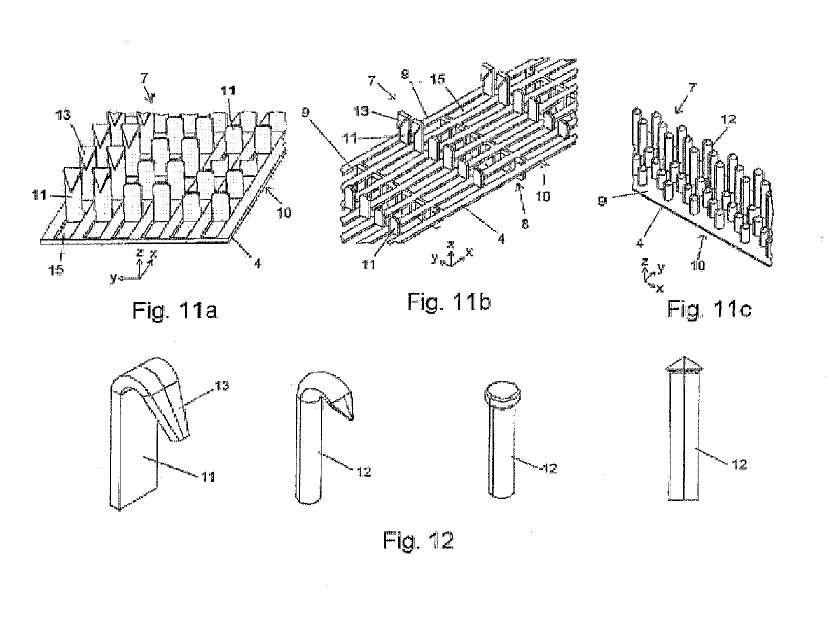

The arrangement of the illustrated anchoring elements 11 and anchoring pins 12 is merely by way of example and can of course vary, as shown in examples in FIGS. 11 and 12.

FIG. 11a shows in this case a combination of the first exemplified embodiment of a first anchoring portion 7 of FIG. 8 with and without barbs 13 and different lengths of anchoring elements 11. FIG. 11b shows a simultaneous formation with a second anchoring portion 8. FIG. 11c shows anchoring pins 12 of different sizes.

FIG. 12 shows an anchoring element 11 with a bent-over barb 13. FIG. 12 also shows anchoring pins 12 with various head designs. The anchoring pin 12 on the left has a pointed and bent-over head, the anchoring pin on the right next to it is provided with a type of nail head, wherein the anchoring pin 12 illustrated to the right of it has a point with a projecting edge.

The anchoring elements 11 and anchoring pins 12 are produced e.g. in one piece with the metal foil 4. However, it is also possible for the anchoring pins (see FIG. 12) to be produced separately and then welded against or onto the metal foil 4. The metal foil 4 can also already have anchoring elements 11 (and also punched-out parts or only punched-out parts) produced by punch-bending methods.

Although the present invention has been described in this case with the aid of preferred exemplified embodiments, it is not restricted thereto but rather can be modified in a variety of ways.

For instance, in the case of the fourth exemplified embodiment as shown in FIG. 5, the metal foil 4 can be used for introducing heat or assisting the welding procedure, e.g. by means of induction.

In the case of a method for connecting a fibre composite component 2 to a structural component 3 of an aircraft and spacecraft, a metal foil 4 is provided as a transverse reinforcement element between the fibre composite component 2 and the structural component 3. It is formed with at least one anchoring portion 7 which protrudes from the surface 9 facing the fibre composite component 2 and is inserted between the fibre composite component 2 and the structural component 3. A corresponding arrangement is produced in accordance with this method.

What is claimed is:

1. A method for connecting a fibre composite component to a structural component of an aircraft and spacecraft, comprising the steps of:
providing a metal foil as a transverse reinforcement element between the fibre composite component and the structural component;
forming the metal foil with at least one anchoring portion which protrudes from the surface facing the fibre composite component (2); and
inserting the metal foil between the fibre composite component and the structural component.

2. The method of claim 1, wherein the metal foil is connected to the fibre composite component by curing of same, if the fibre composite component is uncured or is partially cured, wherein the at least one anchoring portion extends into the fibre composite component.

3. The method of claim 1, wherein the metal foil is connected to the fibre composite component by means of a first adhesive layer therewith, if the fibre composite component is cured, wherein the at least one anchoring portion extends into the first adhesive layer.

4. The method of claim 1, wherein the metal foil is connected to the structural component by means of a second adhesive layer, if the structural component is a metallic part or has a cured fibre composite structure.

5. The method of claim 4, wherein the metal foil is connected to the structural component by means of a further anchoring portion which protrudes from the surface facing the structural component and extends into the second adhesive layer.

6. The method of claim 1, wherein the method comprises the following additional method steps, if the structural component has an uncured or a partially cured fibre composite structure:
forming the metal foil with a further anchoring portion which protrudes from the surface facing the structural component; and
connecting the further anchoring portion to the structural component by curing of same, wherein the further anchoring portion extends into the structural component.

7. The method of claim 1, wherein the method comprises the following additional method steps, if the fibre composite component and the structural component each comprise a thermoplastic laminate:
forming the metal foil with at least one further anchoring portion which protrudes from the surface facing the structural component; and
welding the fibre composite component to the structural component after insertion of the metal foil, wherein the anchoring portions extend into the respectively associated component.

8. The method of claim 7, wherein during the welding procedure the metal foil is used at least partially for the purpose of coupling heat in, e.g. by induction.

9. The method of claim 1, wherein the metal foil is formed with at least one anchoring portion by means of at least one of the following: punch-bending methods, high-speed metal removal, electron beam processing, additive layer manufacturing methods or welding of anchoring elements or anchoring pins or anchoring elements and anchoring pins.

10. A method for connecting a fibre composite component to a structural component of an aircraft and spacecraft, comprising the steps of:
providing a metal foil as a transverse reinforcement element in a connection portion of the fibre composite component and the structural component;
forming the metal foil with at least one anchoring portion which protrudes from a surface of the metal foil; and
disposing the metal foil on an outer side of the connection portion, wherein the at least one anchoring portion extends completely through the fibre composite component and extends into the structural component or extends completely through the structural component and extends into the fibre composite component.

11. The method of claim 10, wherein the metal foil is formed with at least one anchoring portion by means of at least one of the following: punch-bending methods, high-speed metal removal, electron beam processing, additive layer manufacturing methods, welding of anchoring elements or anchoring pins or anchoring elements and anchoring pins.

12. An arrangement comprising a fibre composite component and a structural component of an aircraft and spacecraft, in which a metal foil is inserted in a connection portion of the fibre composite component and structural component as a transverse reinforcement element, wherein the metal foil comprises at least one anchoring portion which protrudes from a surface of the metal foil.

13. The arrangement of claim 12, wherein the metal foil comprises a further anchoring portion which protrudes from the surface of the metal foil facing the structural component.

14. The arrangement of claim 12, wherein the at least one anchoring portion or the further anchoring portion or at least one anchoring portion and the further anchoring portion are formed as punch-bent parts and comprise anchoring elements which are disposed substantially perpendicularly or at a predetermined angle with respect to the respective surface of the metal foil.

15. The arrangement of claim 12, wherein the at least one anchoring portion or further anchoring portion or the at least one anchoring portion and further anchoring portion comprise anchoring pins which are produced by means of electron beam processing or additive layer manufacturing methods or electron beam processing and additive layer manufacturing methods.

16. The arrangement of claim 12, wherein the at least one anchoring portion or further anchoring portion or the at least one anchoring portion and further anchoring portion comprise anchoring pins which are separately produced and welded.

17. The arrangement of claim 12, wherein the anchoring elements are provided with barbs or serrations or barbs and serrations.
